(19) United States
(12) Patent Application Publication
(10) Pub. No.: US 2011/0038471 A1
(43) Pub. Date: Feb. 17, 2011

(54) Dialing Plan Analysis and Cleanup

(75) Inventor: Mohana Krishnan Gopalakrishna, Thornton, CO (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/540,983

(22) Filed: Aug. 13, 2009

(51) Int. Cl. H04M 3/42

(52) U.S. Cl. 379/201.01; 379/142.06

(57) ABSTRACT

A method is disclosed that enables a user to administer a dialing plan or plans. The disclosed private-branch exchange, or other type of telephone exchange or switch, analyzes the dialing plan that it uses and then makes a recommendation for the dialing plan. In order to analyze the dialing plan, the private-branch exchange (PBX) considers the usage characteristics of one or more number-consuming objects, which includes the telephone numbers associated with the dialing plan. The PBX then identifies, for possible deletion, a list of inactive or underutilized objects such as unused telephone numbers. In some embodiments, the PBX can anticipate the future availability of telephone numbers based on the usage characteristics that were part of the analysis. In at least some of those embodiments, the PBX is able to construct a dialing plan tree and identify a revised dialing plan.

### FIELD OF THE INVENTION

The present invention relates to telecommunications in general, and, more particularly, to analyzing a dialing plan at data-processing system and identifying telephone numbers for possible deletion.

### BACKGROUND OF THE INVENTION

In a telecommunications system, a dialing plan establishes the expected number and pattern of digits for a telephone number. A dialing plan accounts for country codes, area codes, access codes, and all combinations of dialed digits that are used within the telecommunications system. For example, the North American Numbering Plan is based on ten-digit numbers, in which each number is divided into a three-digit area code and a seven-digit telephone number, which is in turn subdivided into a three-digit central office code and a four-digit station number.

Private-branch exchanges (PBX), as well as other telephone exchanges, manage calls by using dialing plans, or “dial plans.” Typically, a PBX supports variable-length dialing plans that use three to eleven digits. At the PBX, as well as at some other types of exchanges or switches, the dialing plans further comprise telephone numbers that have been allocated for use at the PBX. For example, a PBX dialing plan comprises the telephone numbers that have been allocated to the telephones within the organization served by the PBX.

In an ever-changing organization, the size of the organization can change or the particular combination of staff on role can change over time. Consequently, the dialing plan has to evolve as well in order to accommodate the number and particular combination of telephone extensions that need to be allocated. For example, the telephone extensions allocated through one dialing plan might not be sufficient later on. Furthermore, a telephone extension previously serving an employee who is no longer with an organization could go unused indefinitely.

Therefore, what is needed is a technique that assists telecommunications administrators in the management of an evolving dialing plan.

### SUMMARY OF THE INVENTION

The present invention enables a user, such as a telecommunications equipment administrator, to administer a dialing plan or plans. In accordance with the illustrative embodiment of the present invention, a private-branch exchange, or other type of telephone exchange or switch, analyzes the dialing plan that it uses and then makes a recommendation for the dialing plan. In order to analyze the dialing plan, the private-branch exchange (PBX) considers the usage characteristics of one or more number-consuming objects—which as a result are also memory-consuming objects—which includes the telephone numbers associated with the dialing plan. The PBX then identifies, for possible deletion, a list of inactive or underutilized objects such as unused telephone numbers. In some embodiments, the PBX can anticipate the future availability of telephone numbers based on the usage characteristics that are used in the analysis. In at least some of those embodiments, the PBX is able to construct a dialing plan tree and identify a revised dialing plan.

The private-branch exchange of the illustrative embodiment analyzes the dialing plan, as well as other number-consuming objects, based on one or more usage characteristics. These usage characteristics can be based on a number of factors. As a first example, a first usage characteristic can be based on the amount of time that has elapsed since a particular telephone number was last used. As a second example, a second usage characteristic can be based on the number of times a particular telephone number has been used since the telephone number was provisioned. And as a third example, a third usage characteristic can be based on the number of times a particular telephone number has been used since any telephone number was last deleted.

Advantageously, the technique of the illustrative embodiment frees up memory at the targeted switch by analyzing the usage of telephone numbers and other stored objects at the switch, by autonomously identifying those objects that can be deleted and, in some embodiments, by subsequently deleting those objects identified. This is in contrast to at least some techniques in the prior art, which require a manual approach by a telecom administrator. By automating the process, the technique of the illustrative embodiment enables an administrator to free up memory that would have otherwise gone unused for a prolonged period of time.

The illustrative embodiment of the present invention comprises: provisioning a telephone number for use at a data-processing system, resulting in the telephone number being stored in a memory; and identifying the telephone number for deletion from the memory, based on how the telephone number has been utilized by the data-processing system according to a first usage characteristic and during at least a portion of time since the telephone number was stored in the memory.

### BRIEF DESCRIPTION OF THE DRAWINGS

FIG. 1 depicts data-processing system 100 in accordance with the illustrative embodiment of the present invention.

FIG. 2 depicts the various databases that are stored at data-processing system 100.

FIG. 3 depicts a flowchart of the salient tasks associated with the operation of the illustrative embodiment of the present invention.

### DETAILED DESCRIPTION

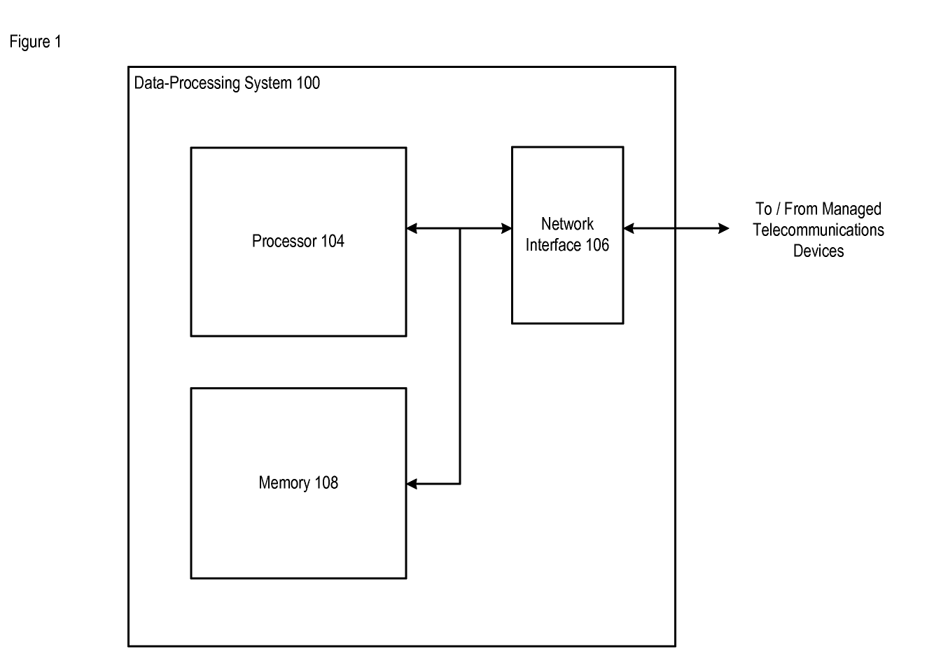

FIG. 1 depicts data-processing system 100 in accordance with the illustrative embodiment of the present invention. Data-processing system 100 is a device that manages calls and performs the tasks of the illustrative embodiment. System 100 comprises processor 104, network interface 106, and memory 108, interconnected as shown.

In the illustrative embodiment, data-processing system 100 is a private-branch exchange (PBX), thereby providing one type of call management. However, it will be clear to those skilled in the art how to make and use alternative embodiments of the present invention in which system 100 is another type of call manager such as a telecommunications switch, a packet router, a Session Initiation Protocol (SIP) server, and so forth.

Data-processing system 100 comprises an arrangement of components at one or more locations that operate to manage and control telephony communications for devices within one or more telecommunications networks. Such networks include a wireless or wired network, a private or public network, or home or office network, and so forth. Thus, processor 104 comprises one or more microprocessors, controllers, logic devices and/or other suitable equipment for executing software, logic, or other control applications such as manager application 200. It will be clear to those skilled in the art how to make and use processor 104.

Network interface 106 comprises hardware and associated controlling logic for linking components of data-processing system 100 and for connecting data-processing system 100 to other devices and telecommunications networks. In some embodiments, network interface 106 provides connectivity between two or more managed devices. For example, network interface 106 might be connected to an Internet Protocol (IP) network that interconnects IP telephony devices (e.g., IP desksets, etc.) of a network. It will be clear to those skilled in the art how to make and use network interface 106.

Memory 108 comprises an arrangement of volatile or non-volatile, local or remote data storage devices. It will be clear to those skilled in the art how to make and use memory 108.

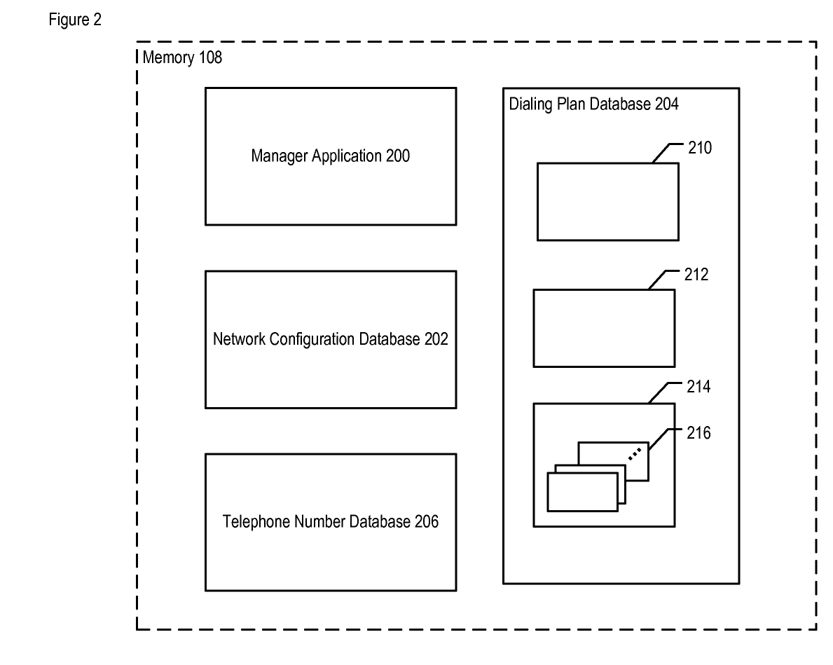

FIG. 2 depicts the various databases that are stored in memory 108 in accordance with the illustrative embodiment of the present invention. The stored databases include manager application 200, network configuration database 202, dialing plan database 204, and telephone number database 206, in accordance with the illustrative embodiment.

Data-processing system 100, using manager application 200, manages telephony communications for one or more managed devices such as telecommunications endpoints (e.g., desksets, cellular telephones, softphones, etc.) This includes the routing of calls from these devices using information maintained in telephone number database 206.

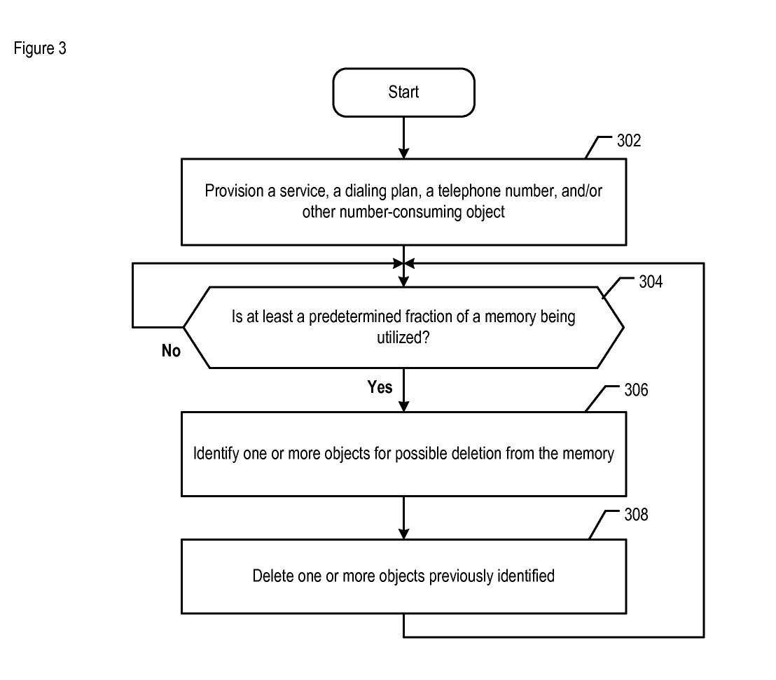

Manager application 200 comprises logic, such as computer software, for controlling the operation of data-processing system 100, including the management of telephony communications for the managed devices. Application 200 also comprises the logic for performing the tasks described below and with respect to FIG. 3, in accordance with the illustrative embodiment of the present invention.

Network configuration database 202 comprises information describing connected networks, network configurations, managed devices, and other appropriate network information for controlling the routing and management of telephony communications. For example, network configuration database 202 might comprise an IP address of data-processing system 100 and information that identifies various available gateways for routing packet-based telephone calls placed from managed devices to equipment connected to the public switched telephone network (PSTN).

Dialing plan database 204 specifies information for the transforming or processing of route patterns, which are part of routing data 210, resulting in the generation of at least some of the telephone numbers in telephone number database 206, as well as in the storing of those telephone numbers into database 206. In accordance with the illustrative embodiment, dialing plan database 204 further comprises pattern processing data 212 and numbering plans 214 that specify one or more route pattern definitions 216. Pattern processing data 212 comprise information for combination with route patterns in order to generate entries for telephone number database 206.

Routing data 210 comprises route patterns that have been set by an administrator and/or other device to specify the routing of telephone calls from managed devices. For example, a selected route pattern might specify a pattern to match against dialed digits received from a managed device and an indication of a device or devices to route the call to upon matching the dialed digits to the specified pattern. In addition, the route patterns can specify transformations to the digits identifying the calling party as well as the digits identifying the called party. For example, to map numbers from the PSTN to an enterprise network, data-processing system 100 might transform a ten-digit number into a four-digit number expected by the private network, such as in the direct inward dialing (DID) that is part of the private-branch exchange functionality in the illustrative embodiment.

The one or more numbering plans 214 define the route patterns for particular regions or define customized numbering plans. In accordance with the illustrative embodiment, numbering plans 214 comprise route pattern definitions 216 to define route patterns for the North American Numbering Plan (NANP). Each route pattern definition 216 defines a string for a route pattern using one or more sub-strings. In some embodiments, data-processing system 100 implements numbering plan 214 as a text file having a series of entries. Each pattern definition defines a particular pattern for potentially comparing with digits dialed by a device managed by data-processing system 100. Thus, to fully implement a selected numbering plan, a file and/or other data structure can potentially have tens or hundreds of route pattern definitions 216.

Although the illustrative embodiment comprises specific data sets maintained as various separate blocks and as depicted in FIG. 2, data-processing system 100 can provide for other suitable separations and/or combinations of various routing data in alternative embodiments. Thus, data-processing system 100 can maintain routing data 210, pattern processing data 212, and numbering plans 214, or their equivalents, in any suitable format such as tables in a database and/or one or more text files.

The illustrative embodiment features a dialing plan being provisioned by data-processing system 100, resulting in one or more telephone numbers being used up and in the dialing plan and/or consumed telephone numbers being stored in memory 108. However, it will be clear to those skilled in the art, after reading this specification, how to make and use alternative embodiments in which data-processing system 100 provisions and manages other telecommunications services other than basic call delivery that result in one or more objects being stored in memory 108, in which those objects might or might not result in one or more telephone numbers being consumed.

FIG. 3 depicts a flowchart of the salient tasks associated with the operation of the illustrative embodiment of the present invention. As those who are skilled in the art will appreciate, in some alternative embodiments, only a subset of the depicted tasks is performed. In some other alternative embodiments, at least some of the tasks are performed simultaneously or in a different order from that depicted.

At task 302, data-processing system 100 provisions one or more dialing plans for use in the delivery of calls. As part of the provisioning, system 100 receives commands from an administrator or other device, such as commands that are related to the entry of data into one or more fields at a workstation. System 100 generates additional data, such as one or more telephone numbers, as a result of the entry data being received. For example, an administrator might enter a range of Direct Inward Dialing (DID) numbers, as well as other objects that consume telephone numbers within system 100. Examples of these objects include telephone extensions, hunt groups, vector directory numbers, call agents, call announcements, music sources, and so forth.

At task 304, data-processing system 100 checks whether a predetermined fraction of memory 108 is being utilized. If system 100 detects that the predetermined fraction of memory 108 is being utilized, task execution proceeds to task 306. Otherwise, system 100 continues to perform its other functions and continues to check the memory utilization, either periodically or sporadically.

At task 306, data-processing system 100 identifies one or more objects for possible deletion from memory 108, based on analyzing how one or more telephone numbers have been utilized by system 100. A telephone number can be one such object that system 100 identifies for deletion, as those who are skilled in the art will appreciate. In accordance with the illustrative embodiment, system 100 evaluates the utilization of the telephone numbers according to one or more usage characteristics and during at least a portion of the time since the one or more objects were stored in memory 108.

In accordance with the illustrative embodiment, system 100 performs task 306 in response to it having detected at task 304 that at least the predetermined fraction of memory is being utilized. In some alternative embodiments, however, the execution of task 306 is based on something other than or in addition to having detected that the predetermined fraction of memory is being utilized.

The usage characteristics that system 100 considers in the evaluation can be based on a number of factors. As a first example, a first usage characteristic can be based on the amount of time that has elapsed since a particular telephone number—or a particular dialing plan, for that matter—was last used. As a second example, a second usage characteristic can be based on the number of times a particular telephone number has been used since either a dialing plan or the telephone number itself was provisioned. And as a third example, a third usage characteristic can be based on the number of times a particular telephone number (or dialing plan) has been used since any telephone number (or dialing plan) was last deleted. The usage characteristics can be based on other factors as well, as those who are skilled in the art will appreciate.

In some embodiments, data-processing system 100 identifies a revised dialing plan, based on analyzing how one or more telephone numbers have been utilized by system 100. In those embodiments, system 100 evaluates the utilization of the telephone numbers according to one or more usage characteristics and during at least a portion of the time since the dialing plan that is currently in effect was stored in memory 108. In some scenarios, in order to reduce the occupancy of memory 108, the number of telephone numbers used up by the revised dialing plan is less than, but is certainly no greater than, the number of telephone numbers used up by the dialing plan that is currently in effect. For example, if a dialing plan with four-digit extensions was allocated in anticipation of a large workforce in the future, but if system 100 determines that only 200 numbers have been regularly used over a long period, system 100 might recommend a dialing plan with three-digit extensions.

Alternatively, system 100 might recommend a revised dialing plan that consumes more telephone numbers than the current dialing plan. In addition, system 100 identifies for deletion telephone numbers in the current dialing plan, in order to reduce memory utilization. For example, if a dialing plan with three-digit extensions is currently in use, and if system 100 determines that 900 numbers are being regularly used compared to 800 numbers a year ago, system 100 might recommend a revised dialing plan with four-digit extensions in anticipation of future needs.

At task 308, data-processing system 100 deletes the telephone number or numbers, or other objects identified at task 306, from memory 108. In some embodiments, task 308 is performed autonomously, while in other embodiments, task 308 is performed based at least in part on administrator intervention.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
provisioning a telephone number for use at a data-processing system, resulting in the telephone number being stored in a memory; and
identifying the telephone number for deletion from the memory, based on how the telephone number has been utilized by the data-processing system according to a first usage characteristic and during at least a portion of time since the telephone number was stored in the memory.

2. The method of claim 1 wherein the first usage characteristic is based on the amount of time that has elapsed since the telephone number was last used.

3. The method of claim 1 wherein the first usage characteristic is based on the number of times the telephone number has been used since the telephone number was provisioned.

4. The method of claim 1 wherein the first usage characteristic is based on the number of times the telephone number has been used since any telephone number was last deleted.

5. The method of claim 1 wherein the telephone number is provisioned and stored as part of a range of telephone numbers.

6. The method of claim 1 wherein the identifying of the telephone number occurs as a result of a dialing plan being analyzed.

7. The method of claim 1 further comprising detecting that at least a predetermined fraction of the memory is being utilized, wherein the identifying occurs in response to the detecting.

8. The method of claim 1 further comprising deleting the telephone number from the memory in response to the identifying of the telephone number.

9. A method comprising:
provisioning a telecommunications service for use at a data-processing system, resulting in a first object being stored in a memory, the first object using up at least one telephone number; and
identifying the first object for deletion from the memory, based on how the at least one telephone number has been utilized by the data-processing system according to a first usage characteristic and during at least a portion of time since the first object was stored in the memory.

10. The method of claim 9 wherein the first object is a hunt group.

11. The method of claim 9 wherein the first object is a vector directory number.

12. The method of claim 9 wherein the first usage characteristic is based on the amount of time that has elapsed since the at least one telephone number was last used.

13. The method of claim 9 wherein the first usage characteristic is based on the number of times the at least one telephone number has been used since the telecommunications service was provisioned.

14. The method of claim 9 wherein the first usage characteristic is based on the number of times the at least one telephone number has been used since any telephone number was last deleted.

15. The method of claim 9 further comprising detecting that at least a predetermined fraction of the memory is being utilized, wherein the identifying occurs in response to the detecting.

16. A method comprising:
provisioning a first dialing plan for use at a data-processing system, resulting in at least one telephone number being used up and the first dialing plan being stored in a memory; and
identifying a revised dialing plan, based on how the at least one telephone number has been utilized by the data-processing system according to a first usage characteristic and during at least a portion of time since the first dialing plan was stored in the memory, the number of telephone numbers used up by the revised dialing plan being no greater than the number of telephone numbers used up by the first dialing plan.

17. The method of claim 16 wherein the first usage characteristic is based on the amount of time that has elapsed since the at least one telephone number was last used.

18. The method of claim 16 wherein the first usage characteristic is based on the number of times the at least one telephone number has been used since the first dialing plan was provisioned.

19. The method of claim 16 wherein the first usage characteristic is based on the number of times the at least one telephone number has been used since any telephone number was last deleted.

20. The method of claim 16 further comprising detecting that at least a predetermined fraction of the memory is being utilized, wherein the identifying occurs in response to the detecting.
